(19) United States
(12) Patent Application Publication
(10) Pub. No.: US 2007/0052916 A1
(43) Pub. Date: Mar. 8, 2007

(54) Detachable lens of an eyeglasses structure

(76) Inventor: Ping-Fu Zeng, Taichung City (TW)

Correspondence Address: BIRCH STEWART KOLASCH & BIRCH, PO BOX 747, FALLS CHURCH, VA, 22040-0747, US

(21) Appl. No.: 11/209,814

(22) Filed: Aug. 24, 2005

(51) Int. Cl. G02C 5/00

(52) U.S. Cl. 351/41

(57) ABSTRACT

The present invention discloses a detachable lens of eyeglasses structure that includes a lens and a connecting section. An embedded connecting device installed on either the left or the right side of the lens and the connecting section, such that the lens and the connecting section can be connected or detached easily by the embedded connecting device and the lens can be detached from a nose bridge or a frame easily.

### FIELD OF THE INVENTION

The present invention generally relates to eyeglasses, and more particularly to a detachable lens of an eyeglasses structure.

### BACKGROUND OF THE INVENTION

Eyeglasses are an indispensable article for nearsighted people, and the weight of a pair of eyeglasses is a key factor to the comfort of a wearer. Therefore, frameless glasses have become a favorite to nearsighted people. However, the frameless glasses are fixed by drilling holes and its manufacture is not easy. The frameless glasses are difficult to disassemble or replace, and thus it is difficult to repair the frameless glasses if damaged. As a result, the cost of frameless glasses cannot be lowered and the user requirements cannot be meet.

### SUMMARY OF THE INVENTION

Therefore, it is a primary objective of the present invention to provide a detachable lens of eyeglasses structure, that easily detaching and replacing a lens from a nose bridge or a frame by an embedded connecting device.

To achieve the foregoing objective of the present invention, a detachable lens of eyeglasses structure in accordance with the present invention comprises a lens and a connecting section, wherein the lens and the connecting section (could be a nose bridge or a frame) includes an embedded connecting device either on the left or right side, such that the embedded connecting device can be installed to or removed from the lens and the connecting section.

### BRIEF DESCRIPTION OF THE DRAWINGS

FIG. 1 is a schematic view of a first preferred embodiment of the present invention;

FIG. 2A is another schematic view of a first preferred embodiment of the present invention;

FIG. 2B is an enlarged view of part of FIG. 2A;

FIG. 2C is another enlarged view of part of FIG. 2A;

FIG. 3 is a schematic view of a second preferred embodiment of the present invention;

FIG. 4A is a schematic view of an embedded connecting device according to another preferred embodiment of the present invention;

FIG. 4B is an enlarged view of part of FIG. 4A; and

FIG. 4C is another enlarged view of part of FIG. 4A.

### DETAILED DESCRIPTION OF THE PREFERRED EMBODIMENTS

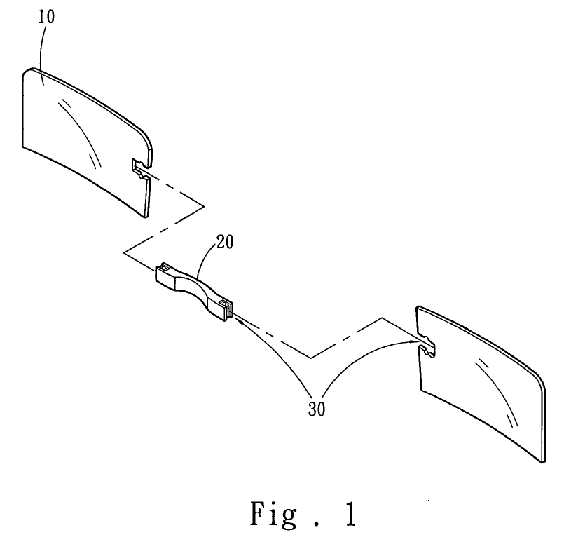

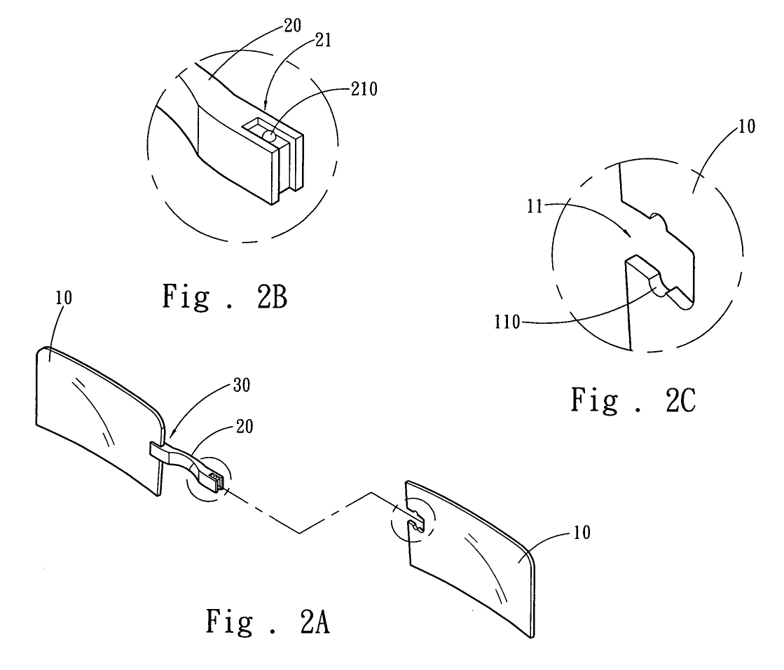

Referring to FIGS. 1 and 2A for the schematic perspective views of a first preferred embodiment of the present invention, a detachable lens of eyeglasses structure is used for removing or replacing the lens from the nose bridge. The present invention comprises a lens 10 and a connecting section 20 which is a nose bridge for the first preferred embodiment. The lens 10 and the connecting section 20 (or the nose bridge) include an embedded connecting device 30 disposed on one side for detaching the lens 10 from the connecting section 20 (or the nose bridge).

Referring to FIGS. 2B and 2C, the embedded connecting device 30 includes an embedded groove 11 disposed on the lens 10. The embedded groove 11 includes a recession 110, the embedded connecting device 30 includes an embedded section 21 disposed on the connecting section 20 (or nose bridge), and the embedded connecting section 21 includes a protrusion 210 corresponding to a recession 110 of the embedded connecting groove 11 of the lens 10, such that the protrusion 210 and the recession 110 are used to assemble or detach the lens 10 and the connecting section 20 (or the nose bridge).

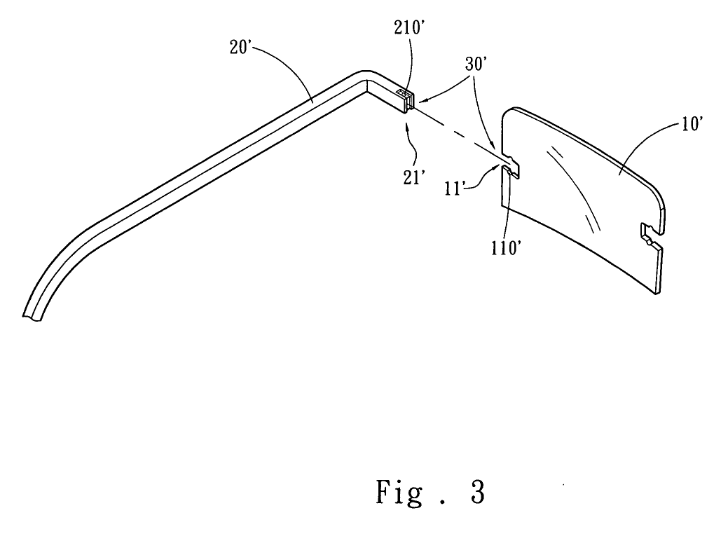

Refer to FIG. 3 for the detachable lens of an eyeglasses structure according to a second preferred embodiment. The connecting section 20′ could be a frame (same as the frame described in the first preferred embodiment), and the embedded connecting device 30′ includes an embedded connecting groove 11′ on the lens 10′, and the embedded connecting groove 11′ includes a recession 110′. The embedded connecting device 30′ includes an embedded connecting section 21′ on the connecting section 20′ (or the frame), and the embedded connecting section 21′ includes a protrusion 210′ corresponding to the recession 110′ of the embedded connecting groove 11′ of the lens 10′, such that the protrusion 210′ and the recession 110′ can be used to assemble or detach the lens 10′ and the connecting section 20′ (or the frame).

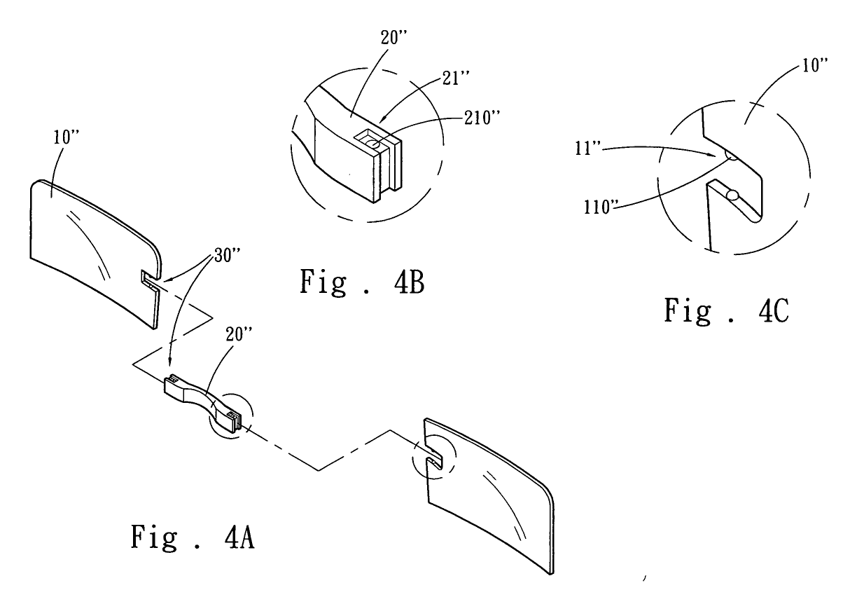

Refer to FIGS. 4A, 4B and 4C for the embedded connecting device according to another preferred embodiment. The connecting section 20″ is a nose bridge, the embedded connecting device 30″ includes an embedded section 11″ on the lens 10″ includes a protrusion on the embedded section 11″, and the embedded connecting device 30″ includes an embedded connecting groove 21″ on the connecting section 20″ (the nose bridge). The embedded connecting groove 21″ includes a recession 210″ corresponding to the protrusion 110″ of the embedded section 11″ of the lens 10″, such that the embedded connecting device 30″ is used to detach or assembly the lens 10″ and the connecting section 20″ (the nose bridge).

It is worth to point out that the protrusions 210, 210′, 110″ are made of a contractible and flexible material regardless of the first preferred embodiment or the second preferred embodiment, so that the protrusions 210, 210′, 110″ can be embedded into the recessions 110, 110′, 210″ easily.

In view of the description above, the present invention provides a detachable lens of an eyeglasses structure that uses an embedded connecting device to easily detach or replace a lens from the nose bridge or the frame.

What is claimed is:

1. A detachable lens of an eyeglasses structure, comprising:
a lens;
a connecting section; and
an embedded connecting device, disposed on a side of said lens and said connecting section for coupling and detaching said lens with said connecting section by means of an embedment.

2. The detachable lens of an eyeglasses structure of claim 1, wherein said embedded connecting device of said lens includes an embedded connecting groove, said embedded connecting groove includes a recession, said embedded connecting device of said connecting section includes an embedded section, and said embedded section includes a protrusion corresponding to said recession of said embedded connecting groove of said lens, so as to achieve a detachment and an assembling by said recession and said protrusion.

3. The detachable lens of an eyeglasses structure of claim 2, wherein said protrusion is contractible and flexible.

4. The detachable lens of an eyeglasses structure of claim 1, wherein said embedded connecting section of said lens includes an embedded section, said embedded section includes a protrusion, said embedded connecting device of said connecting section includes an embedded connecting groove, and said embedded connecting groove includes a recession corresponding to said protrusion of said embedded connecting groove of said lens, so as to achieve a detachment and an assembling by said recession and said protrusion.

5. The detachable lens of an eyeglasses structure of claim 1, wherein said protrusion is contractible and flexible.

6. The detachable lens of an eyeglasses structure of claim 1, wherein said connecting section is a nose bridge.

7. The detachable lens of an eyeglasses structure of claim 1, wherein said connecting section is a frame.
